(19) United States
(12) Patent Application Publication
(10) Pub. No.: US 2009/0059105 A1
(43) Pub. Date: Mar. 5, 2009

(54) System and Method for Controlled Illumination

(76) Inventor: Giovanni COLELLA, Glen Cove, NY (US)

Correspondence Address: Fay Kaplun & Marcin, LLP/ Motorola, 150 Broadway Suite 702, New York, NY, 10038, US

(21) Appl. No.: 11/846,922

(22) Filed: Aug. 29, 2007

(51) Int. Cl. G02F 1/13357; F21V 3/00; G02F 1/1333

(52) U.S. Cl. 349/33; 349/62; 362/311

(57) ABSTRACT

An electronic device having a first component requiring a first lighting configuration, a second component requiring a second lighting configuration, an illumination component that creates an artificial lighting and a window disposed over the illumination component so that when the artificial lighting is passed through the window, the window is configured to produce one of the first lighting configuration and the second lighting configuration.

### FIELD OF THE INVENTION

The present invention relates generally to a system and method for controlled illumination. Specifically, a level of illumination is controlled based on a type of application.

### BACKGROUND

A mobile unit may be equipped with a variety of components to increase a number of functionalities executable by the unit. For example, the mobile unit may be equipped with a camera. Because the camera may be used in an environment where an ambient lighting is low, the mobile unit may further be equipped with a flash or light emitting diode. In another example, the mobile unit may be equipped with a scanner. The scanner may also be used in the environment where the ambient lighting is low. However, utilizing the same flash or light emitting diode for the scanner may not be optimal. For example, the flash for a camera may be too directional when a broader illumination is preferable for a scanner. In addition, a flash or light emitting diode designed for the scanner may not be optimal for the camera. For example, a broad illumination may not provide enough lighting on a specific point in which a picture is to be taken. Furthermore, including a flash for each application may unduly increase an overall size of the mobile unit.

### SUMMARY OF THE INVENTION

An electronic device having a first component requiring a first lighting configuration, a second component requiring a second lighting configuration, an illumination component that creates an artificial lighting and a window disposed over the illumination component so that when the artificial lighting is passed through the window, the window is configured to produce one of the first lighting configuration and the second lighting configuration.

A method for determining an application to be used, determining a lighting configuration to be used with the application and configuring a window so that when an artificial lighting is passed through the window, the lighting configuration to be used with the window is produced.

An electronic device having a window configured to create a first lighting configuration and a second lighting configuration and a processor determining an application to be executed by the electronic device and sending a signal to the window to create one of the first and second lighting configurations corresponding to the application.

### DESCRIPTION OF THE DRAWINGS

FIG. 1 shows components of a mobile unit according to an exemplary embodiment of the present invention.

FIG. 2 shows a cross sectional view of a window and LED portion of the mobile unit of FIG. 1 according to an exemplary embodiment of the present invention.

FIG. 3a shows a first resulting light path for the mobile unit of FIG. 1 according to an exemplary embodiment of the present invention.

FIG. 3b shows a second resulting light path for the mobile unit of FIG. 1 according to an exemplary embodiment of the present invention.

FIG. 4 shows a method for controlled illumination according to an exemplary embodiment of the present invention.

### DETAILED DESCRIPTION

The exemplary embodiments of the present invention may be further understood with reference to the following description and the appended drawings, wherein like elements are referred to with the same reference numerals. The exemplary embodiments of the present invention describe a system and method for controlled illumination. Specifically, the mobile unit (MU) of the exemplary embodiments may include a window disposed over a light emitting diode (LED) that controls a level of illumination. The MU, the window, and the LED will be discussed in more detail below.

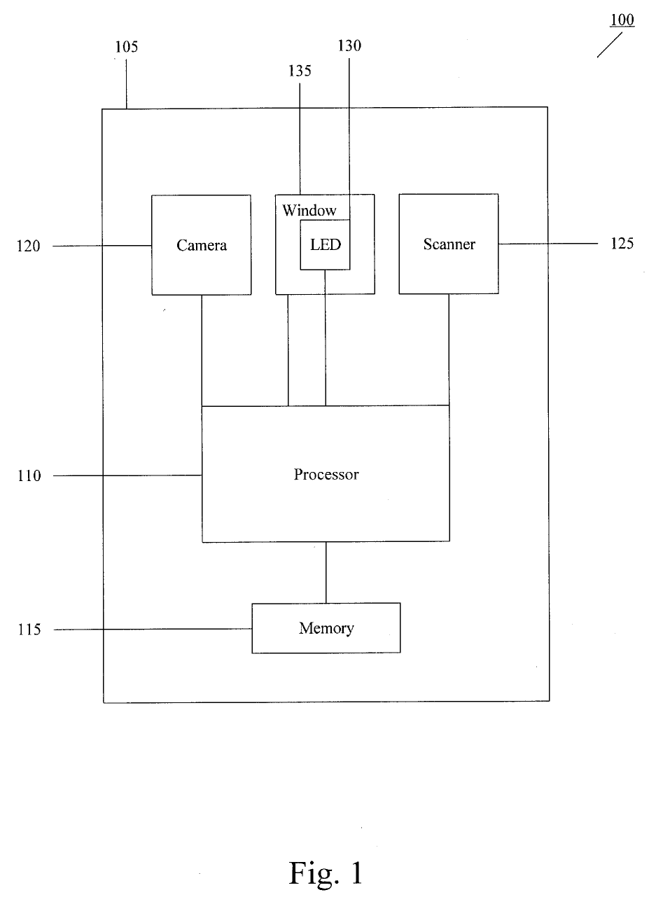

FIG. 1 shows components of an MU 100 according to an exemplary embodiment of the present invention. The MU 100 may be any portable electronic device with at least two components that may require an illumination system. In this example, the MU 100 includes a camera 120 and a scanner 125 that use an illumination system. Those skilled in the art will understand that there may be other or additional types of components on the MU 100 that may also use an illumination system. In addition, it may also be that a single component may use different levels of illumination depending on an operating mode of the component (e.g., a camera may use a first illumination level for a wide operating mode and a second illumination level for a zoom operating mode). Thus, the exemplary embodiments of the present invention do not require two components that use the illumination system.

The MU 100 may be, for example, a laptop, a pager, a cell phone, a radio frequency identification device, a data acquisition device, etc. It should be noted that the use of the MU 100 is only exemplary. That is, the exemplary embodiments of the present invention may apply to any electronic device that utilizes components that may use an illumination system. According to the exemplary embodiments of the present invention, the MU 100 may include at least a housing 105, a processor 110, a memory 115, the camera 120, the scanner 125, a light emitting diode (LED) 130, and a window 135.

The housing 105 may at least partially encase the components of the MU 100. For example, the processor 110 and the memory 115 may be entirely disposed within the housing 105. In another example, the camera 120 and the scanner 125 may be partially disposed within the housing. Those skilled in the art will understand that the camera 120 and the scanner 125 may require a line of sight to an object. Thus, the camera 120 and the scanner 125 may include a portion that is disposed on a periphery of the housing 105. It should be noted that the MU 100 may include further components such as a network device (e.g., transceiver), an antenna, a battery, a display, a data input arrangement, etc. The further components may also be entirely disposed within (e.g., network device, battery) or partially disposed within (e.g., antenna, display, data input arrangement) the housing 105.

The processor 110 may be responsible for executing various functionalities of the MU 100. Specifically, according to the exemplary embodiments of the present invention, the processor 110 may be responsible for controlling an illumination based on a type of functionality that the MU 100 executes. The memory 115 may be a storage unit for the MU 100. Specifically, the memory 115 may store a program relating to the controlled illumination and data and/or settings pertaining to the controlled illumination.

The camera 120 may be a component of the MU 100 that enables a capturing of an image. For example, the camera 120 may be a digital camera that includes a series of lenses that focus light to create an image of a scene. The light may be focused onto a semiconductor that records data corresponding to the focused light (e.g., pixel data). The data may then be received by the processor 110 to create an image data file (e.g., a JPEG file) that may be stored on the memory 115. Ff an image is being captured in a low ambient lighted environment, an illumination system may be used.

The scanner 125 may be a component of the MU 100 that enables a scanning of data. The data that is scanned may be in a variety of forms. For example, the data may be in the form of a barcode (e.g., one-dimensional, two-dimensional), an image, etc. Thus, the scanner 125 may be a barcode scanner, a laser scanner, an imager, etc. Those skilled in the art will understand that no matter what type that the scanner 125 is, in a low ambient lighted environment, an illumination system may be used to properly scan the data.

The LED 130 may be a component of the MU 100 that serves to represent an exemplary illumination system. That is, the LED 130 may be any illuminating device that provides an artificial lighting. As illustrated, the LED 130 is the illuminating device. However, those skilled in the art will understand that other types of illuminating devices may also be used, for example, a light bulb. The LED 130 may be disposed entirely within a recess of the housing 105. That is, the housing 105 may be shaped to include a line of sight specifically for the LED 130. It should be noted that according to the exemplary embodiments of the present invention, an intensity of the LED 130 may be controlled. The window 135 may be a component of the MU 100 that protects the LED 130. Furthermore, as will be described in detail below, the window 135 may also provide a mechanism to control which configuration of illumination is used based on the functionality being used by the MU 100.

As illustrated, the memory 115, the camera 120, the scanner 125, the LED 130, and the window 135 may all be electronically connected to the processor 110. The electronic connection from the processor 110 to the memory 115 may allow data stored in the memory 115 to be retrieved or data to be stored in the memory 115. Those skilled in the art will understand that the memory 115 may be a volatile memory (e.g., RAM), non-volatile memory (e.g., flash memory), or a combination thereof. The electronic connection from the processor 110 to the camera 120, the scanner 125, and the LED 130 may allow signals to be transmitted and/or received to activate the components, exchange data, etc. The electronic connection from the processor 110 to the window 135 may be a current carrying connection. That is, the processor may route a current from a power supply (e.g., battery) to the window 135. As will be described in greater detail below, the application of current to the window 135 may control the operation of the window 135.

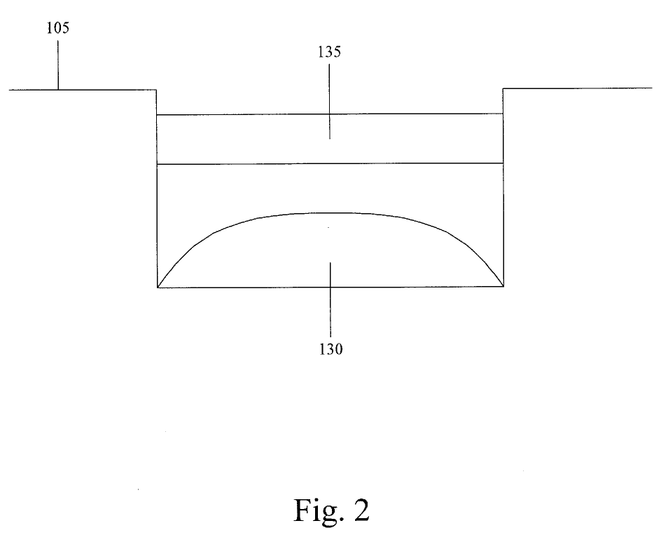

FIG. 2 shows a cross sectional view of the MU 100 of FIG. 1 according to an exemplary embodiment of the present invention. Specifically, the cross sectional view is focused around an area of the MU 100 where the LED 130 and the window 135 are disposed. The window 135 may be a polymer dispersed liquid crystal (PDLC) window. Thus, when a current is applied to the PDLC window, the PDLC window may switch between a transparent configuration and a dispersed configuration. For example, if a high current is applied to the PDLC window, the liquid crystal molecules may be oriented in the dispersed configuration. In another example, if a low or no current is applied to the PDLC window, the liquid crystal molecules may be oriented in the transparent configuration.

Those skilled in the art will understand that when the camera 120 is being used by the MU 100, the LED 130 may provide a short, intense directional illumination toward an object in which an image is to be taken. Thus, a first current may be applied to the window 135 so that the window 135 exhibits the transparent configuration. In the transparent configuration, the light from the LED 130 may be directed substantially linearly with little to no radiating. Furthermore, the transparent configuration of the window 135 may have little to no interference with a light path so that the light may be directional.

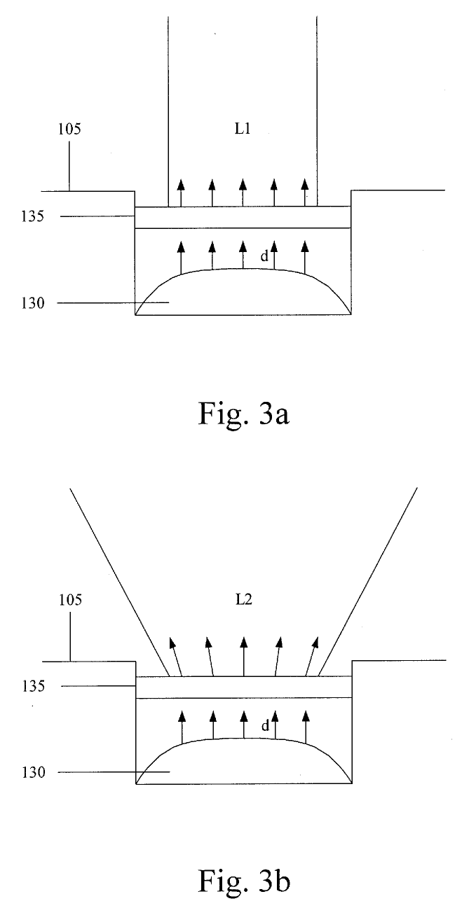

FIG. 3a shows a first resulting light path L1 for the MU 100 of FIG. 1 according to an exemplary embodiment of the present invention. The light may be emitted from the LED 130 in a direction d. Because the window 135 is in a transparent configuration, the light may pass through the window 135 and create the light path L1. That is, as discussed above, the light path may be directed substantially linearly with little to no radiating.

Those skilled in the art will also understand that when the scanner 125 is being used by the MU 100, the LED 130 may provide a long (e.g., in comparison to a flash used with the camera 120), dispersed illumination toward an object to be scanned. Thus, a second current may be applied to the window 135 so that the window 135 exhibits the dispersed configuration. In the dispersed configuration, the light from the LED 130 may be directed substantially linearly toward the window 135. However, the liquid crystals in the window 135 may be oriented in such a way as to make the light path disperse. That is, the light may be reflected or refracted so that a substantially angled path is created for the light. The substantially angled path may create a wider illumination in comparison to the directional illumination of the transparent configuration.

FIG. 3b shows a second resulting light path L2 for the MU 100 of FIG. 1 according to an exemplary embodiment of the present invention. The light may also be emitted from the LED 130 in the direction d. Because the window 135 is in a dispersed configuration, the light may pass through the window 135 and create the light path L2. That is, as discussed above, the light path may be substantially angular by having the light reflect or refract off the liquid crystals. Thus, a wider illumination field is created.

Therefore, according to the exemplary embodiments of the present invention, the window 135 may be adapted into different configurations to provide a corresponding illumination based on a functionality and component being used by the MU 100. It should be noted that the MU 100 may include further components and functionalities that may use the LED 130. In addition, these components and functionalities may require a unique illumination to properly execute. Further currents may be applied to the window 135 to alter the liquid crystals disposed therein so that the light from the LED 130 may create other illuminations. For example, the MU 100 may include a display, a data input arrangement, etc. The LED 130 may create an appropriate lighting so that data may be viewed on the display, keys of the data input arrangement may be seen, etc. As discussed above, the LED 130 may be equipped to change an illumination intensity. The illumination intensity may also be incorporated with the camera 120 (e.g., high intensity), the scanner 125 (e.g., low intensity), and the other components.

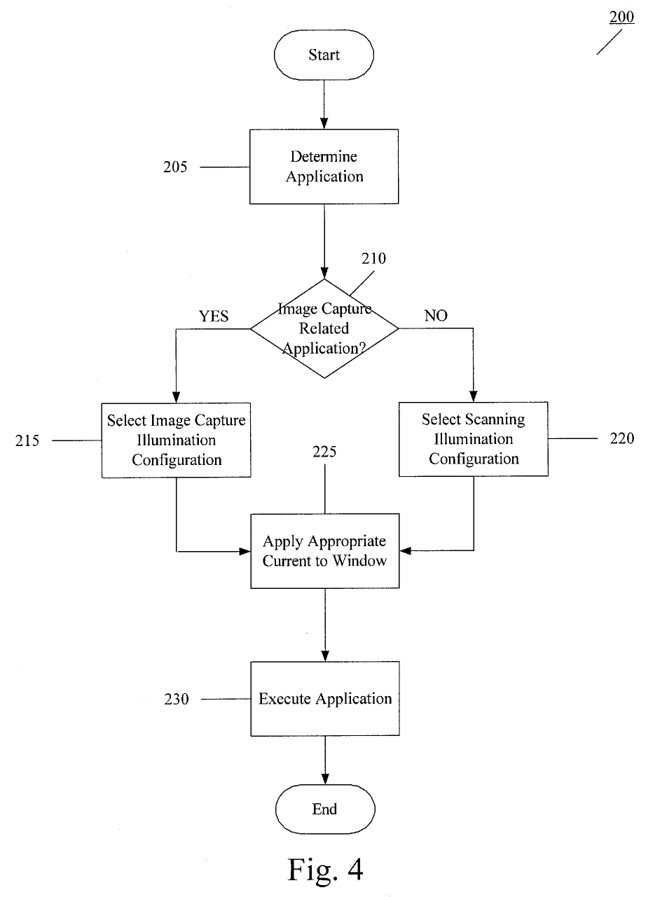

FIG. 4 shows a method 200 for controlled illumination according to an exemplary embodiment of the present invention. The method 200 will be described with reference to the MU 100 of FIG. 1 and the light paths L1 and L2 of FIGS. 3a-b, respectively. The method 200 may assume that the camera 120 and the scanner 125 are the only components of the MU 100 that use the LED 130. However, as discussed above, the MU 100 may include further components that utilize the LED 130. The method 200 may also incorporate the further components.

In step 205, an application that the MU 100 is using is determined. For example, the application may be to capture an image or to perform a scan. Inherent in determining the application is to determine any components of the MU 100 that will be used in conjunction with the application. For example, if the application is to capture an image, the camera 120 may be used; if the application is to perform a scan, the scanner 125 may be used; etc.

In step 210, a determination is made whether the application is related to an image capture functionality. That is, step 210 determines if the camera 120 is being used or if the scanner 125 is being used. If step 210 determines that an image capture functionality is being used, the method 200 continues to step 215 while the method 200 continues to step 220 if the scanner functionality is being used.

In step 215, an image capture illumination configuration is selected. As discussed above, the image capture illumination configuration may be the transparent configuration for the window 135. In step 220, a scanning illumination configuration is selected. As discussed above, the scanning illumination configuration may be the dispersed configuration for the window 135. Furthermore, the illumination configuration may also select an illumination intensity.

In step 225, an appropriate current is applied to the window 135. For the transparent configuration, the current may be applied to orient the liquid crystals so that the light from the LED 130 may not be interfered so that a directed path is created such as the light path L1. For the dispersed configuration, the current may be applied to orient the liquid crystals so that the light from the LED 130 may be interfered so that a wider emanation of light is created such as the light path L2.

In step 230, the application is executed. For example, the camera 120 may be activated to capture an image. At a precise time when a lens aperture is opened to receive light, the LED 130 may also be activated to produce the artificial lighting. In another example, the scanner 125 may be activated to scan an object. The LED 130 may be activated prior to the scanner 125 scanning the image. The artificial light may be produced onto the object so that the scanner 125 may properly scan the object. It should also be noted that steps 225 and 230 may be carried out substantially simultaneously. That is, in order to save power, the current is supplied to the window 135 only when the LED 130 is activated.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. An electronic device, comprising:
a first component requiring a first lighting configuration;
a second component requiring a second lighting configuration;
an illumination component that creates an artificial lighting; and
a window disposed over the illumination component so that when the artificial lighting is passed through the window, the window is configured to produce one of the first lighting configuration and the second lighting configuration.

2. The electronic device of claim 1, wherein the first component is a camera.

3. The electronic device of claim 1, wherein the second component is a scanner.

4. The electronic device of claim 1, wherein the first lighting configuration is an intense, directed lighting.

5. The electronic device of claim 1, wherein the second lighting configuration is a dispersed lighting.

6. The electronic device of claim 1, wherein the window is a polymer dispersed liquid crystal window.

7. The electronic device of claim 6, wherein a respective current is applied to the window to configure the window to produce one of the first and second lighting configurations.

8. The electronic device of claim 1, further comprising:
a third component requiring a third lighting configuration.

9. The electronic device of claim 8, wherein the window is configured to produce the third lighting configuration.

10. The electronic device of claim 8, wherein the third component is one of a display and a data input arrangement.

11. A method, comprising:
determining an application to be used;
determining a lighting configuration to be used with the application; and
configuring a window so that when an artificial lighting is passed through the window, the lighting configuration to be used with the window is produced.

12. The method of claim 11, wherein a first application to be used is an image capture functionality.

13. The method of claim 12, wherein the first application requires an intense, directed lighting.

14. The method of claim 12, further comprising:
producing the artificial lighting substantially concurrently with an execution of the first application.

15. The method of claim 11, wherein a second application to be used is a scanning functionality.

16. The method of claim 15, wherein the second application requires a dispersed lighting.

17. The method of claim 15, further comprising:
producing the artificial lighting prior to an execution of the second application.

18. The method of claim 11, wherein the window is a polymer dispersed liquid crystal window.

19. The method of claim 18, further comprising:
applying a current to the window to configure the window to produce the lighting configuration.

20. The method of claim 11, wherein a third application to be used relates to one of a display and a data input arrangement.

21. An electronic device, comprising:
a first component requiring a first lighting configuration;
a second component requiring a second lighting configuration;
an illumination means for creating an artificial lighting; and
a control means for producing one of the first lighting configuration and the second lighting configuration, the control means being disposed over the illumination means so that the artificial lighting is passed through the control means.

22. An electronic device, comprising:
a window configured to create a first lighting configuration and a second lighting configuration; and
a processor determining an application to be executed by the electronic device and sending a signal to the window to create one of the first and second lighting configurations corresponding to the application.
